(19) United States
(12) Patent Application Publication
(10) Pub. No.: US 2002/0090448 A1
(43) Pub. Date: Jul. 11, 2002

(54) Method, assembly and unit for gumming articles

(75) Inventors: Mario Spatafora, Bologna (IT); Loris Grepioni, Castel Maggiore (IT)

Correspondence Address: Ladas & Parry, 26 West 61 Street, New York, NY, 10023, US

(73) Assignee: G.D SOCIETA' PER AZIONI

(21) Appl. No.: 10/022,484

(22) Filed: Dec. 18, 2001

(30) Foreign Application Priority Data
Dec. 22, 2000 (IT) BO2000A000742

(51) Int. Cl. B05D 1/00

(52) U.S. Cl. 427/8; 118/706

(57) ABSTRACT

A method of gumming articles includes feeding a succession of articles along a feed path by means of a gumming unit having a conveyor for conveying the articles, and two gumming assemblies located on opposite sides of the conveyor to apply respective given quantities of adhesive to each article; supplying adhesive to an outlet of a nozzle of each gumming assembly by means of a respective pump and along an adhesive supply path extending between the pump and the outlet; applying a given quantity of adhesive to each article by means of each nozzle; and metering the quantity of adhesive by means of the pump.

The present invention relates to a method of gumming articles.

More specifically, the present invention relates to a method of gumming packets of cigarettes on a packing machine, to which the following description refers purely by way of example.

### BACKGROUND OF THE INVENTION

On known packing machines, a cardboard blank is folded about a group of cigarettes to form a packet of cigarettes. As it is being folded, various portions of the blank are bonded using adhesive applied beforehand to one of the portions for bonding.

Applying adhesive to a solid support such as a blank is normally referred to as gumming, and cigarette packing machines comprise gumming assemblies for applying adhesive to the flat or, if necessary, partly folded blank. Of the gumming assemblies normally used on cigarette packing machines, a roller gumming assembly is known, which comprises a tank from which a roller draws and transfers adhesive to a blank fed along a path tangent to the roller. Gumming assemblies of this sort call for frequent cleaning and tend to apply a jagged strip of adhesive of uneven thickness.

Other commonly used gumming assemblies on cigarette packing machines are spray guns, which emit small quantities of adhesive at high pressure through nozzles and in time with the blanks as they are fed past. Though successful in certain applications, spray guns have the drawback of failing to keep up with the increasingly fast traveling speed of the blanks on modern packing machines. In particular, the high pressure at which the adhesive is emitted means minute quantities must be transferred in a sequence determined by a valve, which, in turn, means a large number of small, closely spaced quantities of adhesive must be deposited to cover a given area of the blank. In other words, using spray guns, the faster the traveling speed of the blanks, the faster the metering valves must be activated. Moreover, using spray guns, the adhesive tends to drip and set into lumps at the nozzle outlet, thus possibly affecting the direction of the adhesive issuing from the nozzle, and even clogging the outlet.

EP292299 discloses a gluing apparatus for use with a form collator for collating continuous sheets of paper. The collator has a framework 1, a plurality of rollers extending transversely of the framework, each roller being driven by a main motor and having a pin wheel for advancing a continuous sheet of paper hung over the roller. The gluing apparatus is positioned opposite each sheet of paper and comprises a gear pump having an inlet connected to a glue reservoir through a hose and an outlet provided with a nozzle for applying glue to the paper. The gear pump is driven by a motor to skippingly or linearly apply glue according to input data of a programmable computer responsive to pulse signals received from an encoder arranged to sense advancing movement of the paper. In another embodiment, mechanical means such as a cam is provided to swing the gear pump towards and away from the paper.

U.S. Pat. No. 4,787,332 discloses an improved adhesive dispensing pump control system for automatically changing the flow rate of adhesive materials being dispensed onto a workpiece in conformance with changes in movement of an automatically controlled adhesive dispensing nozzle used to apply adhesive materials automatically onto the surface of a workpiece in accordance with a predetermined pattern. In operation, the adhesive or other mastic dispensing pump control system operates to maintain substantially constant inlet and outlet pressure difference across the dispensing pump thereby making the system relatively insensitive to changes in viscosity of the adhesive being dispensed and allowing adhesives to be dispensed at relatively high pressures.

EP709539 discloses an apparatus for double-sided coating of spacer frames for insulating glass panes with an adhesive sealant. The device coats the frame on both sides with sealing and adhesive material. Two nozzles facing each other are mounted close above a horizontal conveyor, and are supplied via a metering device. Each nozzle has its own gear pump, the two being driven in synchronism and drawing from a common tank. The latter can be connected to an adjustable pressure-generator, and between each pump and respective nozzle mouth there can be merely a short passage containing no valves. The pumps can have a reversible drive mechanism, this being electronically synchronised with the drive to the conveyor.

U.S. Pat. No. 4,333,420 discloses a glue applicator for applying glue to a moving web is in the form of a gear pump having its housing in close proximity to the web and having a discharge nozzle adapted to discharge glue directly onto the web. The drive and the mount for the housing permit adjustable movement transversely of and normal to the web.

### SUMMARY OF THE INVENTION

It is an object of the present invention to provide a method of applying adhesive, designed to eliminate the drawbacks of the known state of the art, and which, at the same time, provides for fast, precise application of the adhesive and reduced maintenance.

According to the present invention, there is provided a method of gumming articles, and which comprises feeding said articles along a feed path; supplying adhesive to an outlet of an adhesive application nozzle by means of a pump and along a supply path extending between the pump and the outlet; and applying a given quantity of adhesive to said article by means of said nozzle; the method being characterized by metering said given quantity of adhesive by means of said pump.

The pump can be controlled rapidly and with very little inertia, and permits a greater adjustment range than a metering valve, which simply provides for permitting or preventing adhesive flow.

The present invention also relates to a gumming assembly for applying a given quantity of adhesive to an article.

According to the present invention, there is provided a gumming assembly for applying a given quantity of adhesive to an article fed along a feed path; the gumming assembly comprising an adhesive supply pump, and an adhesive application nozzle having an outlet; said adhesive being supplied to said outlet along a supply path extending between said pump and said outlet; and the gumming assembly being characterized by comprising no metering valves for metering said quantity of adhesive; said pump metering each given quantity of adhesive.

The present invention also relates to a unit for gumming articles.

According to the present invention, there is provided a gumming unit for gumming articles, comprising a conveyor for feeding a succession of articles, equally spaced with a given spacing, along a feed path; and at least one gumming assembly, as claimed in any one of claims 15 to 23, for gumming each article in said succession.

### BRIEF DESCRIPTION OF THE DRAWINGS

A number of non-limiting embodiments of the present invention will be described by way of example with reference to the accompanying drawings, in which:

FIG. 1 shows a plan view, with parts in section and parts removed for clarity, of a gumming unit for implementing the method according to the present invention;

FIG. 2 shows a partly sectioned front view of the FIG. 1 unit;

FIG. 3 shows a view in perspective of a packet formed using the method according to the present invention;

FIG. 4 shows a view in perspective of a partly formed packet gummed in accordance with the method of the present invention;

FIG. 5 shows a larger-scale section of a detail of the FIG. 1 unit.

### DETAILED DESCRIPTION OF THE INVENTION

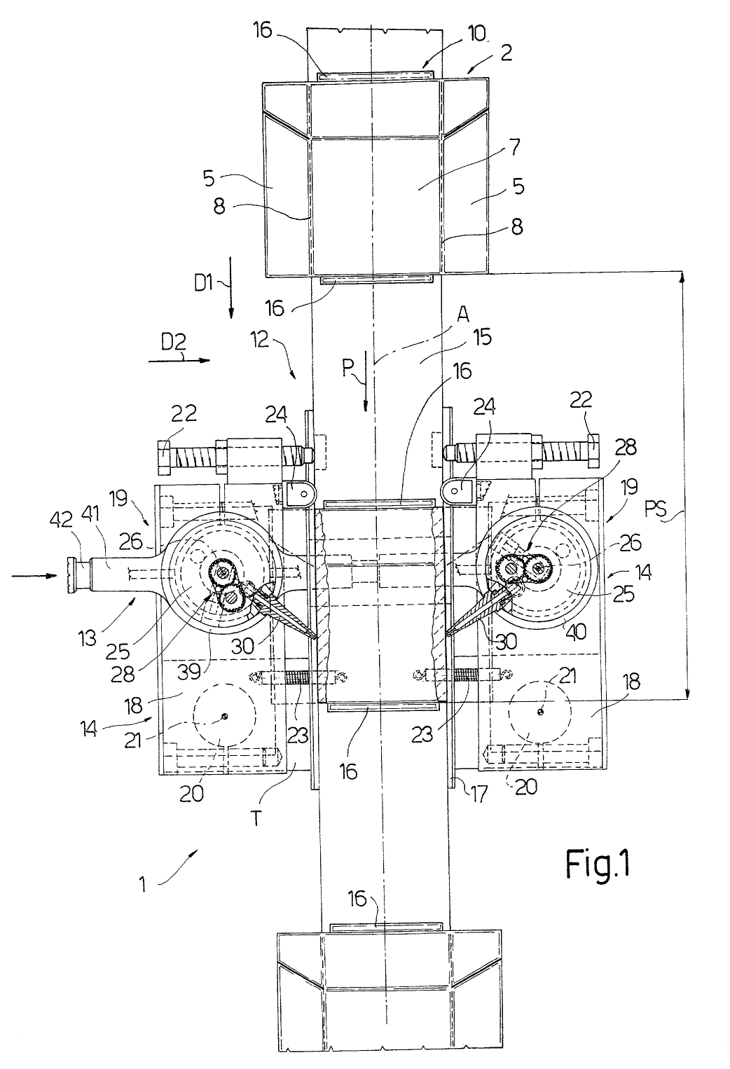

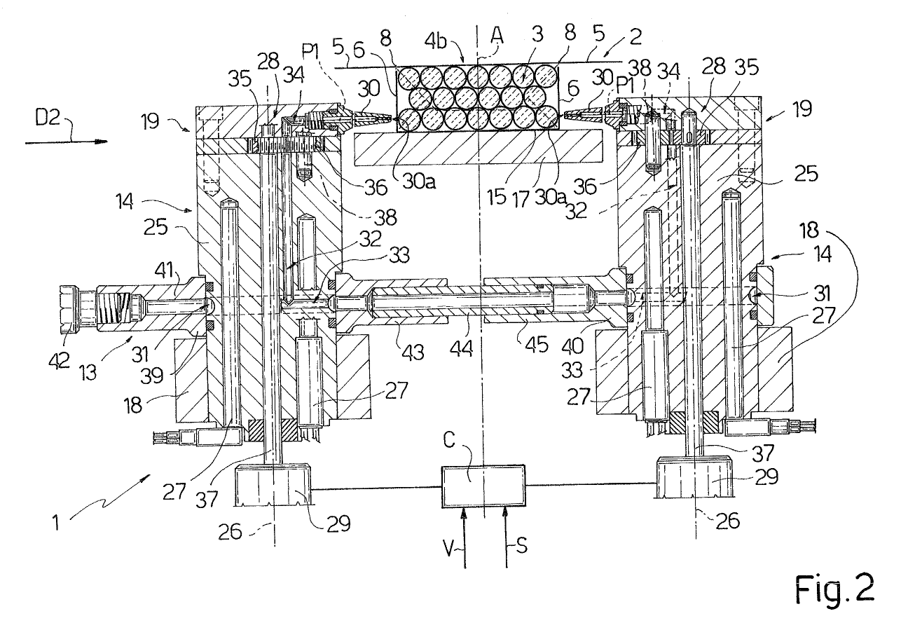

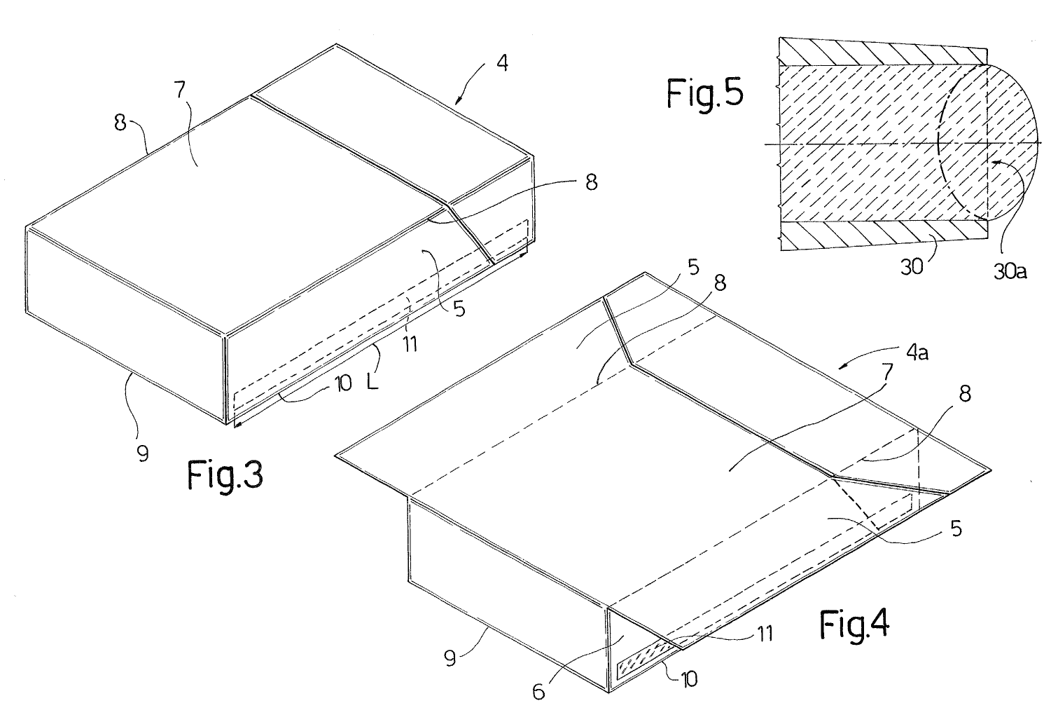

Number 1 in FIGS. 1 and 2 indicates as a whole a gumming unit for applying adhesive to blanks 2, each folded partly about a group 3 of cigarettes (FIG. 2), to form a packet 4 of cigarettes (FIG. 3). Blank 2 folded partly about group 3 of cigarettes forms, in fact, a packet 4a as shown in FIG. 4, and which differs from packet 4 in FIG. 3 by having two tabs 5 to be folded onto respective sides 6 of substantially the same size as respective tabs 5. Packet 4a comprises a panel 7 defining the front wall of packet 4 and which is coplanar with and hinged to tabs 5 along two crease lines 8; and a panel 9 defining the rear wall of packet 4 and forming two right-angles and two edges 10 with sides 6. As shown in FIG. 4, unit 1 provides for depositing two strips 11 of even thickness and a given shape onto sides 6 and at edges 10 of each packet 4a.

With reference to FIGS. 1 and 2, gumming unit 1 is substantially symmetrical with respect to a plane A of symmetry perpendicular to the FIG. 1 and 2 planes, and comprises a frame T; a conveyor 12 extending in a direction Dl to feed packets 4a along a path P; an adhesive supply circuit 13; and two gumming devices 14 located on either side of plane A of symmetry.

With reference to FIG. 1, conveyor 12 comprises a belt 15 extending perpendicularly to plane A of symmetry and having pockets 16 equally spaced with a spacing PS along path P. Each pocket 16 houses a respective packet 4a so as to keep packet 4a in a given position with respect to conveyor 12 in direction D1, with sides 6 parallel to path P and freely accessible. Frame T extends beneath belt 15, supports the two gumming devices 14 in rotary manner, and comprises a plate 17 located directly beneath belt 15 along a portion of path P at gumming devices 14 to prevent belt 15 from flexing at gumming devices 14.

Each gumming device 14 comprises a supporting member 18 and a gumming assembly 19. Supporting member 18 is fixed, at one end, to a shaft 20 rotating with respect to frame T about an axis 21 parallel to plane A, and comprises, at the opposite end, an adjustable stop 22 cooperating with plate 17. Each supporting member 18 is also connected to frame T by a spring 23, which pushes stop 22 against plate 17 to define a given position of respective gumming device 14 with respect to conveyor 12. Supporting member 18 also comprises a guide 24 for adjusting the position of each packet 4a inside respective pocket 16 in a direction D2 perpendicular to direction Dl. Each gumming assembly 19 comprises a cylindrical body 25 having an axis 26 parallel to axis 21, and which is fixed to a respective supporting member 18; electric resistors 27 and a gear pump 28 housed inside body 25; a reversible brushless servomotor 29 for powering pump 28; and an adhesive application nozzle 30 having an outlet 30a. Each body 25 comprises an annular groove 31; a channel 32 parallel to axis 26; a radial channel 33 connecting annular groove 31 and channel 32; and a further L-shaped channel 34 between pump :28 and nozzle 30.

Pump 28 comprises two gears 35 and 36 meshing with each other between channel 32 and channel 34.

Gear 35 is integral with a shaft 37 having an axis coincident with axis 26 and connected to servomotor 29; and gear 36 rotates about an axis 38 parallel to axis 26.

Supply circuit 13 is the only asymmetrical part of unit 1 with respect to plane A of symmetry, and comprises a ring 39 fitted hermetically to body 25 of one gumming assembly 19, and a ring 40 fitted to body 25 of the other gumming assembly 19. Rings 39 and 40 are located at annular grooves 31 of respective gumming assemblies 19, and rotate about respective gumming assemblies 19 and respective axes 26. Ring 39 has, on one side, a fitting 41 connectable to a supply conduit 42, and, on the opposite side, a fitting 43 fitted in sliding manner to a straight pipe 44. Ring 40 differs from ring 39 by having only one fitting 45 similar to fitting 43 and fitted in sliding manner to pipe 44 as shown in FIG. 2.

Gumming unit 1 is controlled by a control unit C shown schematically in FIG. 2 and which receives a signal V related to the traveling speed of conveyor 12, and a signal S related to the presence of packets 4a in pockets 16 of conveyor 12. Both signals V and S are received from respective known sensors not shown, and control unit C also controls activation of servomotors 29 on the basis of the incoming signals V and S.

In actual use, gumming unit 1 provides for applying both hot and cold adhesive. If hot adhesive is used, electric resistors 27 heat body 25, in which channels 32, 33, 34 are formed and which houses pump 28, and heat is transmitted from body 25 to nozzle 30. Adhesive is supplied by supply conduit 42, which feeds the adhesive along fitting 41 of ring 39 to groove 31 of the first gumming assembly 19, and along fitting 45 of ring 40 to annular groove 31 of the second gumming assembly 19. Pipe 44 and fittings 43 and 45 of respective rings 39 and 40 connect the annular grooves 31 of first and second gumming assemblies 19.

The position of each gumming assembly 19 is adjustable, as a function of the position and width of packets 4a, by means of adjustable stops 22, which define a given position of supporting members 18 and, hence, of nozzles 30 with respect to conveyor 12. Rings 39 and 40 rotate about respective bodies 25, and are connected telescopically to each other by pipe 44 to adjust bodies 25 and adapt the shape of circuit 13 to the position of bodies 25. The purpose of the adjustment is to achieve the best distance between outlets 30a of the two nozzles 30 as a function of the width of packets 4a, so that each packet 4a can be fed between the two nozzles 30 with sides 6 at such a distance as to receive a thin, even layer of adhesive.

The distance between outlets 30a of nozzles 30 is also determined as a function of the clearance between sides 6 and respective outlets 30a, which clearance in turn depends on the viscosity of the adhesive used and the pressure at which it is applied.

Once the distance between outlets 30a of nozzles 30 is adjusted, packets 4a are fed along path P in direction D1, and are positioned by guides 24 in direction D2 so that sides 6 of each packet 4a are the same distance from plane A of symmetry.

Packets 4a are fed continuously by conveyor 12 along path P in an orderly succession and equally spaced with spacing PS, and each nozzle 30 applies, synchronously with the passage of each packet 4a, a respective continuous strip 11 of adhesive of length L onto side 6 and at edge 10 of each packet 4a. That is, each nozzle 30 alternates between a work period in which a given quantity of adhesive is emitted and applied, and a rest period in which no adhesive is emitted by the nozzle. The duration of the work and rest periods depends on the traveling speed of conveyor 12, on spacing PS, and on the length L of the strip 11 of adhesive to be applied. Each pump 28 is powered by respective servomotor 29, which is controlled by control unit C as a function of signals V and S, length L of the strip 11 of adhesive to be applied, and spacing PS.

Servomotor 29 is reversible, so that pump 28 can be operated in two opposite directions. When servomotor 29 is operated in a first direction, pump 28 delivers adhesive through nozzle 30 and creates a slightly higher than atmospheric pressure at outlet 30a of nozzle 30 to expel the adhesive from nozzle 30. Conversely, to cut off adhesive flow through outlet 30a, servomotor 29 is operated in a second direction opposite the first, to create a slight vacuum at outlet 30a of nozzle 30 and suck the adhesive projecting from outlet 30a of nozzle 30 back into nozzle 30, as shown clearly in FIG. 5, in which the continuous line shows the free edge of the adhesive projecting from outlet 30a of nozzle 30, and the dash-and-dot line shows the edge of the adhesive sucked back into nozzle 30 as a result of the vacuum formed by pump 28.

In other words, pump 28 meters the amount of adhesive to be applied to packet 4a, with no need for a valve between pump 28 and nozzle 30, and provides for sucking the adhesive projecting from nozzle 30 back into nozzle 30.

The adhesive is applied by spreading the portion of adhesive projecting from the nozzle towards the packet 4b traveling past nozzle 30.

Pump 28 is oversized with respect to the amount of adhesive expelled to form strip 11, so that, to expel strip 11, pump 28 need only be rotated at relatively low speed. For example, rotated at a few tens of revolutions per minute in the first direction, pump 28 produces a pressure of a few tens of bars at gears 35 and 36, and a slightly higher than atmospheric pressure at outlet 30a of nozzle 30. Similarly, rotated at the same speed in the second direction, pump 28 creates a slight vacuum at outlet 30a of nozzle 30. The low rotation speed of pump 28 therefore enables the rotation direction of pump 28 to be inverted, on account of the relatively low forces of inertia involved, and the adhesive pressure to be varied between values above and below atmospheric pressure.

Pump 28 and outlet 30a of nozzle 30 are located close to each other. That is, since the pressure and vacuum generated at outlet 30a depend on the length L1 of the path P1 of the adhesive between pump 28 and outlet 30a, the smaller the length L1 of path P1 is, the more efficient pump 28 is in varying the pressure at outlet 30a. Consequently, length L1 of path P1 of the adhesive between pump 28 and outlet 30a is the minimum compatible with the construction requirements of gumming assembly 19. The rotation direction of each brushless servomotor 29 can therefore be inverted extremely rapidly to suck back the part of the adhesive already issuing from nozzle 30 but not yet applied to side 6 of packet 4a, thus preventing smears and the formation of lumps of dried adhesive integral with the end of nozzle 30.

1) A method of gumming articles, and which comprises feeding said articles (4a) along a feed path (P); supplying adhesive to an outlet (30a) of an adhesive application nozzle (30) by means of a pump (28) and along an adhesive supply path (P1) extending between the pump (28) and the outlet (30a); and applying a given quantity of adhesive to said article (4a) by means of said nozzle (30); the method being characterized by metering said quantity of adhesive by means of said pump (28).

2) A method as claimed in claim 1, characterized by effecting a variation in pressure in said adhesive at said outlet (30a) by means of the pump (28) to meter said adhesive; said variation in pressure ranging between pressure values above atmospheric pressure and values below atmospheric pressure.

3) A method as claimed in claim 2, characterized by generating pressure values above atmospheric pressure in said adhesive at the outlet (30a) of said nozzle (30) to apply said adhesive to said articles (4a).

4) A method as claimed in claim 2, characterized by generating pressure values below atmospheric pressure in said adhesive at said outlet (30a) to arrest application of said adhesive.

5) A method as claimed in claim 1, characterized by operating said pump (28) at different operating speeds, and by inverting the operating direction of the pump (28) to meter said adhesive.

6) A method as claimed in claim 1, characterized in that said pump (28) is reversible.

7) A method as claimed in claim 6, characterized in that said pump (28) is a gear pump (28).

8) A method as claimed in claim 1, characterized by controlling said pump (28) by means of a control unit (C) and as a function of a signal (V) related to the traveling speed of a conveyor (12) of said articles (4a) along said path (P).

9) A method as claimed in claim 8, characterized by controlling said pump (28) by means of said control unit and as a function of a signal (S) related to the presence of an article (4a) on said conveyor (12).

10) A method as claimed in claim 1, characterized in that the nozzle (30) is substantially adjacent to the pump (28) to minimize the length (L1) of the adhesive supply path (P1) between the pump (28) and the outlet (30a).

11) A method as claimed in claim 1, characterized by adjusting the position of the outlet (30a) of said nozzle (30) with respect to a conveyor (12) for supplying said articles (4a).

12) A method as claimed in claim 1, characterized by positioning said articles (4a) at a given distance from said outlet (30a) by means of guide members (24) located along said feed path (P).

13) A method as claimed in claim 1, characterized in that said given quantity of adhesive is applied at an edge (10) of said article (4a).

14) A method as claimed in claim 13, characterized in that said given quantity of adhesive is applied in the form of a strip of given length (L) on a face (6) of said article (4a) fed continuously.

15) A gumming assembly for applying a given quantity of adhesive to an article (4a) fed along a feed path (P); the gumming assembly comprising an adhesive supply pump (28), and an adhesive application nozzle (30) having an outlet (30a); said adhesive being supplied to said outlet (30a) along a supply path (P1) extending between said pump (28) and said outlet (30a); and the gumming assembly being characterized by comprising no metering valves for metering said quantity of adhesive; said pump (28) metering each given quantity of adhesive.

16) An assembly as claimed in claim 15, characterized in that said pump (28) is reversible.

17) An assembly as claimed in claim 15, characterized in that said pump (28) is a gear pump (28).

18) An assembly as claimed in claim 15, characterized by comprising a reversible brushless servomotor (29) for operating said pump (28).

19) An assembly as claimed in claim 15, characterized in that the nozzle (30) is substantially adjacent to the pump (28) to minimize the length (L1) of the adhesive supply path (P1) between the pump (28) and the outlet (30a).

20) An assembly as claimed in claim 15, characterized by comprising a body (25) housing said pump (28); said nozzle being fitted to said body (25).

21) An assembly as claimed in claim 20, characterized by comprising electric resistors (27) housed in cavities formed in the body (25) and for heating the body (25).

22) An assembly as claimed in claim 21, characterized in that said body (25) is cylindrical and has adhesive supply channels (32, 33, 34).

23) An assembly as claimed in claim 22, characterized in that said body (25) comprises an annular groove (31) communicating with said supply channels (32, 33, 34).

24) A gumming unit for gumming articles, comprising a conveyor (12) for feeding a succession of articles (4a), equally spaced with a given spacing (PS), along a feed path (P); and at least one gumming assembly (19), as claimed in claim 15, for gumming each article (4a) in said succession.

25) A gumming unit as claimed in claim 24, characterized by comprising a control unit (C) for controlling a pump (28) as a function of a signal (V) related to the traveling speed of the conveyor.

26) A gumming unit as claimed in claim 24, characterized by comprising a frame (T); and a supporting member (18) for supporting said gumming assembly (19) and hinged to said frame (T).

27) A gumming unit as claimed in claim 24, characterized by comprising two gumming assemblies (19) located on opposite sides of said conveyor (12).

28) A gumming unit as claimed in claim 27, characterized by comprising adjusting means (22) for adjusting the position of each gumming assembly (19) with respect to said conveyor (12).

29) A gumming unit as claimed in claim 28, characterized by comprising a supply circuit (13) for supplying adhesive to said gumming assemblies (19); said supply circuit (13) being adaptable to the positions assumed by said gumming assemblies.

30) A gumming unit as claimed in claim 29, characterized in that each gumming assembly (19) comprises a cylindrical body 825) having an annular groove (31); said supply circuit (13) comprising a first and a second ring (39, 40) located about the respective bodies (25) at said annular grooves (31); and said rings (39, 40) rotating hermetically about said bodies (25) to convey said adhesive to said bodies (25).

31) A gumming unit as claimed in claim 30, characterized in that the first ring and the second ring (39, 40) are connected to each other by a pipe (44) to which they are connected telescopically.
